(19) United States
(12) Patent Application Publication
(10) Pub. No.: US 2018/0118110 A1
(43) Pub. Date: May 3, 2018

(54) Rearview Mirror Hanger

(71) Applicants: Chad S. Frampton, American Fork, UT (US); Darcy W. Greep, Herriman, UT (US)

(72) Inventors: Chad S. Frampton, American Fork, UT (US); Darcy W. Greep, Herriman, UT (US)

(21) Appl. No.: 15/795,244

(22) Filed: Oct. 26, 2017

Related U.S. Application Data
(60) Provisional application No. 62/414,713, filed on Oct. 29, 2016.

(51) Int. Cl. B60R 1/04

(52) U.S. Cl. CPC B60R 1/04; B60R 2011/0033

(57) ABSTRACT

A device for attaching to an internal rearview mirror of a vehicle that provides a hook for hanging eyeglasses, sunglasses, or other items. The device attaches to the mirror with a spring clamp system that securely holds it in place. The spring clamp system does not hang below the mirror so as to minimize interference with driver visibility through the windshield and does not cover the mirror so as to prevent obstruction of the driver's reflected view in the mirror. The hooks can be located purposely in the zone directly behind the mirror so as to minimize interfering with driver field of view. Hooks may also be located so as to extend above, below, or to the side of the mirror depending on the desired location. The spring clamp device has a flexible design, allowing attachment to a large variety of vehicle internal rearview mirrors.

### RELATED APPLICATIONS

This application claims priority to U.S. Provisional Patent Application No. 62/414,713, filed Oct. 29 2016, in the United States Patent and Trademark Office, and entitled, “REARVIEW MIRROR HANGER”, which application is incorporated by reference in its entirety herein.

### BACKGROUND

Drivers of, and passengers in motor vehicles often wear sunglasses for safety, clear visibility, and eye protection while traveling. When exiting a vehicle, sunglasses are often removed and left in the vehicle, especially if the wearer is going indoors where sunglasses are not typically needed. In addition, at night, sunglasses are usually removed and may be placed on the dash, the console, the seat, or left elsewhere in the vehicle.

Eyeglasses may be worn to correct vision for drivers of, or passengers in motor vehicles: distance vision correction for nearsighted individuals; near vision correction for far sighted individuals; bifocal, trifocal, or progressive vision correction for age affected individuals; as well as other issues such as astigmatism, strabismus, etc.

Eyeglasses/sunglasses (eyewear) are often damaged, destroyed, or lost when left in a vehicle glove box or console caddy, or on a dashboard, console, or seat. The damage or loss occurs when they are scratched by contact with other items, fall to the floor, are stepped on, sat on, or otherwise crushed, become wedged under or between seats, are smashed in closing doors, or even fall out of an open door.

To safely store eyewear and prevent such problems, newer vehicles have built-in eyeglass/sunglass holders that often only have room for one pair.

In older vehicles without built-in holders or in newer vehicles without additional built-in holders, the storage of eyewear has been addressed by the creation of several devices to help hold eyewear when not being worn. Examples may include, locking clip-on holders that attach to a sun-visor, internal rearview mirror hanging attachments, dashboard or center console holders that are held in place with adhesives, suction cups, silicone pads, or even weighted bases, and hooks that attach to the windshield, side window, rearview mirror, or other surfaces with suction cups or adhesives.

While each of these add-on holders serves a purpose, they are often inconveniently located or interfere with the field of vision of the driver, or result in damage to the vehicle's interior. For instance, locking clips that attach to sun-visors may not adjust enough to securely hold all varieties of eyewear, or may damage eyewear if not properly positioned before closing of the locking clip. Adhesive residues often remain on surfaces after a holder is removed leaving unsightly and sometimes damaging marks.

Embodiments of the present disclosure seek to overcome certain limitations of these devices by providing a safe and secure device and method for quickly locating eyewear, and other items, in a convenient central location that limits interference with the driver's field of vision and accommodates all styles of eyewear as well as other items desired to be located by hanging for easy and safe access.

### BRIEF SUMMARY

The present disclosure relates generally to rearview mirror hangers for conveniently locating eyewear, and other items, in a safe and secure central location, which limits interference with the driver's field of vision.

According to one exemplary configuration of the present disclosure the rearview mirror hanger can include a spring clamp with two flex members forming one side of the rearview mirror attachment and two rigid opposing members, located opposite the flex members. In addition, a connecting member is used to join the flex members and the rigid opposing members to complete the offset clamping mechanism. This connecting member may also include an area for decoration, such as a logo or other pattern or design. One or more hooks may be attached to the connecting member, the flex member, or the rigid opposing member to provide a functional component from which to hang eyewear or other items. The hook or hooks may be placed in a manner that locates a majority of the eyewear or other items being hung from the hanger, in a position behind the mirror so that the driver's vision is minimally obstructed. This locating of eyewear or other items in the area of the rearview mirror makes access by both the driver or front seat passenger easy as they are maintained in a central location. In addition, this location does not require the driver to remove their eyes from the road when accessing such eyewear or other items and does not interfere with centrally located vehicle features such as radios, navigation systems, environmental controls, vents, clocks, thermometer readouts and so forth.

According to another exemplary embodiment of the present disclosure, the rearview mirror hanger can include a spring clamp with two flex members forming one side of the rearview mirror attachment and one rigid opposing member, located opposite the flex members. This single rigid opposing member may be centrally located or closer to one flex member than the other. As in the previous configuration, a connecting member is used to join the flex members and the rigid opposing member to complete the offset clamping mechanism. This connecting member may also include an area for decoration, such as a logo or other pattern or design. One or more hooks may be attached to the connecting member, the flex member, or the rigid opposing member to provide a functional component from which to hang eyewear or other items. The hook or hooks may be placed in a manner that locates a majority of the eyewear or other items being hung from the hanger, in a position behind the mirror so that the driver's vision is minimally obstructed. More than one of these hangers may be attached to a single rearview mirror as desired.

According to another exemplary embodiment of the present disclosure, the rearview mirror hanger can include a spring clamp with two or more flex members forming one side of the rearview mirror attachment and two or more rigid opposing members, located opposite the flex members. As in the previous configurations, one or more connecting members can be used to join the flex members and the rigid opposing members to complete the offset clamping mechanism. The one or more connecting members may also include an area or areas for decoration, such as logos or other patterns or designs. One or more hooks may be attached to the one or more connecting members, the one or more flex members, or the one or more rigid opposing members to provide functional components from which to hang eyewear or other items. The one or more hooks may be placed in a manner that locates a majority of the eyewear or other items being hung from the hanger, in a position behind the mirror so that the driver's vision is minimally obstructed.

According to another exemplary embodiment of the present disclosure, the rearview mirror hanger can include a spring clamp with two flexing members forming one side of the rearview mirror attachment and two or more rigid opposing members located opposite the flexing members. The flexing members in this embodiment are flexed downward and toward each other to open the gap between the flexing members and the rigid opposing members during installation on the mirror, then released to provide clamping force to the mirror to hold the rearview mirror hanger securely in place. As in the previous configurations, one or more connecting members can be used to join the flexing members and the rigid opposing members to complete the offset clamping mechanism. The one or more connecting members may also include an area or areas for decoration, such as logos or other patterns or designs. One or more hooks may be attached to the one or more connecting members, the one or more flexing members, or the one or more rigid opposing members to provide functional components from which to hang eyewear or other items. The one or more hooks may be placed in a manner that locates a majority of the eyewear or other items being hung from the hanger, in a position behind the mirror so that the driver's vision is minimally obstructed.

The Brief Summary is provided to introduce a selection of concepts in a simplified form that are further described and illustrated in the Detailed Description and drawings that follow. The Brief Summary is not intended to identify essential features nor be used as an aid in determining scope of the claimed subject matter.

Features of the present invention will become more fully apparent from the following description, or may be learned by the practice of the invention as set forth hereinafter.

### BRIEF DESCRIPTION OF THE DRAWINGS

To further clarify and illustrate the above and other advantages and features of the present disclosure, a more particular description of the invention will be rendered by reference to specific embodiments thereof in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a perspective view of a rearview mirror hanger according to an exemplary embodiment of the present disclosure;

FIG. 1a is a perspective back view of the rearview mirror hanger of FIG. 1 illustrating a variety of additional hanger hook locations;

FIG. 2 is a front view of the rearview mirror hanger of FIG. 1 showing a manner of organizing the clamping system with two bottom and two top clamp contacts;

FIG. 3 is a side view of the rearview mirror hanger of FIG. 1 showing a manner of organizing the clamping system for attachment to an interior rearview mirror;

FIG. 4 is a perspective view of the rearview mirror hanger of FIG. 1 showing attachment of the hanger to a rearview mirror;

FIG. 5 is a side view of the rearview mirror hanger of FIG. 4 illustrating the exemplary clamping attachment of the hanger to a rearview mirror;

FIG. 6 is a front view of the rearview mirror hanger of FIG. 4 showing a manner of attachment to a rearview mirror of the clamping system with two bottom and two top clamping contacts;

FIG. 7 is a perspective view of the rearview mirror hanger of FIG. 4 illustrating the storage of eyewear on one of the hanger hooks provided for that purpose;

FIG. 8 is a side view of the rearview mirror hanger of FIG. 4 showing the placement of eyewear on one of the hanger hooks;

FIG. 9 is a front view of the rearview mirror hanger of FIG. 4 illustrating the exemplary placement and location of eyewear on one of the hanger hooks;

FIG. 10 is a perspective view of a rearview mirror hanger according to an alternative embodiment of the present disclosure with a clamp contact ratio of two top clamp contacts to one bottom clamp contact;

FIG. 10a is a perspective view of the rearview mirror hanger of FIG. 10 illustrating an additional hanger hook location;

FIG. 11 is a front view of the rearview mirror hanger of FIG. 10 showing a manner of organizing the clamping system with two top clamp contacts and one bottom clamp contact;

FIG. 12 is a side view of the rearview mirror hanger of FIG. 10 showing a manner of organizing the clamping system for attachment to an interior rearview mirror;

FIG. 13 is a perspective view of the rearview mirror hanger of FIG. 10 showing attachment of the hanger to a rearview mirror;

FIG. 14 is a side view of the rearview mirror hanger of FIG. 13 illustrating the exemplary clamping attachment of the hanger to a rearview mirror;

FIG. 15 is a front view of the rearview mirror hanger of FIG. 13 showing a manner of attachment to a rearview mirror of the clamping system with two top and one bottom clamp contacts;

FIG. 16 is a perspective view of an alternative configuration of the rearview mirror hanger of FIG. 1 showing attachment of the hanger to a rearview mirror;

FIG. 17 is a front view of the rearview mirror hanger of FIG. 16 showing a manner of attachment to a rearview mirror of the alternative configuration clamping system with two bottom and two top clamping contacts;

FIG. 18 is a side view of the rearview mirror hanger of FIG. 16 illustrating the alternative configuration clamping attachment of the hanger to a rearview mirror;

FIG. 19 is a perspective view of a rearview mirror hanger according to an exemplary embodiment of the present disclosure which illustrates the flexing members which must be flexed downwardly and toward each other during application of the rearview mirror hanger, and then released to apply the clamping force which holds the rearview mirror hanger in place on the rearview mirror;

FIG. 20 is a front view of the rearview mirror hanger of FIG. 19 showing a manner of organizing the clamping system with two bottom and two top clamp contacts;

FIG. 21 is a side view of the rearview mirror hanger of FIG. 19 showing a manner of organizing the clamping system for attachment to an interior rearview mirror;

FIG. 22 is a rear view of the rearview mirror hanger of FIG. 19 showing multiple possible locations for hooks from which eyewear or other items can be hung.

FIG. 23 is a perspective view of the rearview mirror hanger of FIG. 19 showing attachment of the hanger to a rearview mirror and placement of eyewear on one of the hanger hooks.

FIG. 24 is a side view of the rearview mirror hanger of FIG. 19 showing the placement of eyewear on one of the hanger hooks; and

FIG. 25 is a front view of the rearview mirror hanger of FIG. 19 illustrating the exemplary placement and location of eyewear on one of the hanger hooks.

### DETAILED DESCRIPTION

The present disclosure relates generally to rearview mirror mounted hanging devices for eyewear and other items. More specifically, the present disclosure relates to rearview mirror mounted hanging devices for eyewear and other items with opposing and/or off-set clamping members and attached hooks that allow for central placement and easy access of hanging items, with minimal obstruction of the driver's field of vision both through the windshield as well as reflected views in the mirror.

In contrast to other devices that attach to the dash, window, door, windshield, or even the rearview mirror of a motor vehicle, the construction and features of the rearview mirror hanger of the present disclosure allows it to be attached to a variety of rearview mirrors, and provide for minimal obstruction of the driver's view both from the mirror and through the windshield, while providing a safe, central location for placing eyewear and other items within easy reach of the driver or front seat passenger.

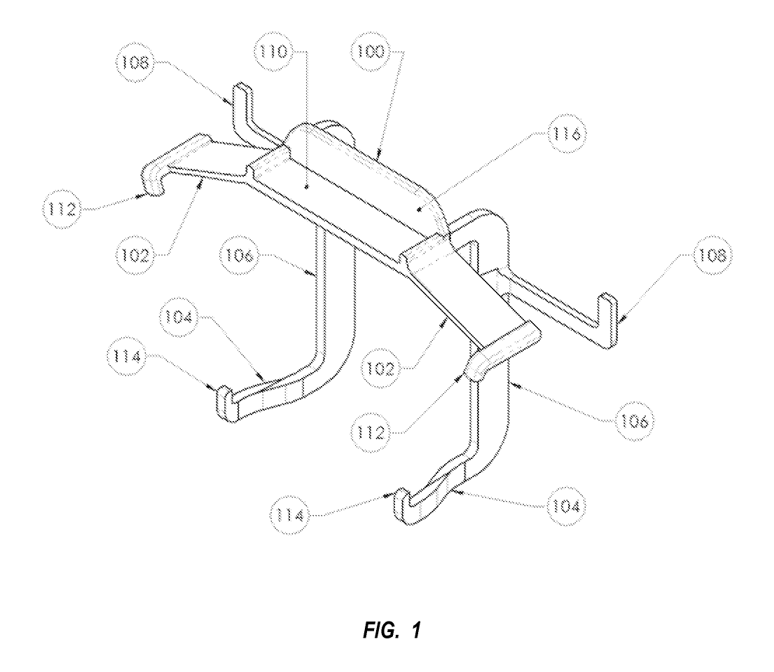

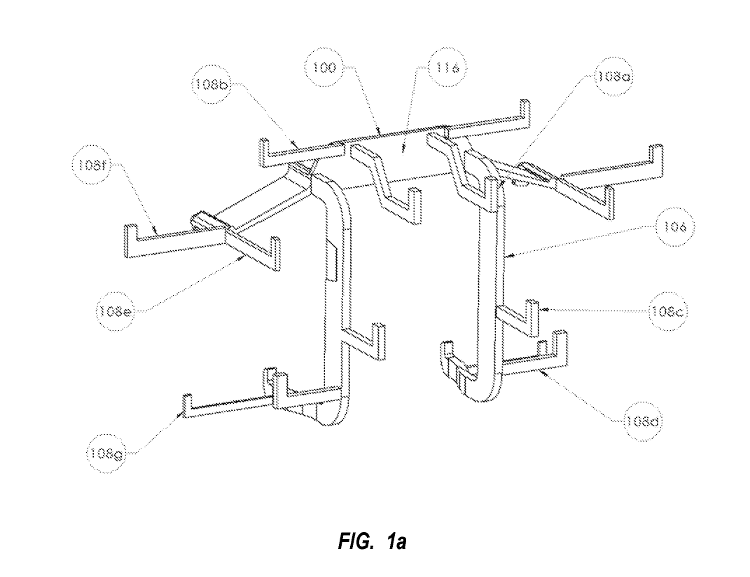

FIG. 1 illustrates an exemplary embodiment that can include some or all of the features of the present disclosure. In FIG. 1, a rearview mirror hanger 100 is illustrated, which includes two flex members 102, two rigid opposing members 104, two connecting members 106, and two hooks 108.

Flex members 102 of rearview mirror hanger 100 are continuously connected by a rigid cross-member 110, which is located across the top edge of a rearview mirror when the rearview mirror hanger 100 is attached to the rearview mirror. Rigid cross-member 110 also continuously joins connecting members 106 to flex members 102 of the rearview mirror hanger 100.

Connecting members 106 are continuously attached to rigid opposing members 104 to complete the clamping mechanism of the rearview mirror hanger 100. In addition, in this exemplary system, hook members 108 are continuously attached to, and extend from connecting members 106, from which eyewear or other items may be hung or supported. In other embodiments, hook members 108a, 108b, 108c, 108d, 108e, 108f, and 108g are attached to, and extend from respective vertical rigid member 116, connecting members 106, rigid opposing members 104, and/or flex members 102 as illustrated in FIG. 1a.

In order to maintain position on a rearview mirror, hooked tips 112 on the flex members, and hooked tips 114 on the rigid opposing members 104 are included. Hooked tips 112 and 114 are purposely kept small to minimize any obstruction of the mirror surface so that the driver's view of reflected images from the mirror is unimpeded.

The flex members 102 and all other parts of the rearview mirror hanger may be composed of a plastic such as ABS, Polycarbonate, Nylon, Polypropylene, Polyurethane, Silicone or other flexible polymers or mixtures of polymers and fillers such as glass or carbon fiber. Flex members 102 and all other parts of the rearview mirror hanger may alternatively be composed of stamped and formed, machined, or otherwise shaped metal or metal wires, either bare or coated with a flexible coating or polymer. Flex members 102 and all other parts of the rearview mirror hanger may also be made from naturally flexing materials such as wood, bamboo or other suitable plant or animal based materials or composites.

Vertical rigid member 116 is included and attached to rigid cross-member 110 and may serve the purpose of adding strength and stiffness to rigid cross-member 110, or may serve a decorative purpose only by displaying a logo or other pattern or design, or it may serve a dual purpose of adding strength and stiffness to rigid cross-member 110 as well as a decorative purpose by displaying a logo or other pattern or design.

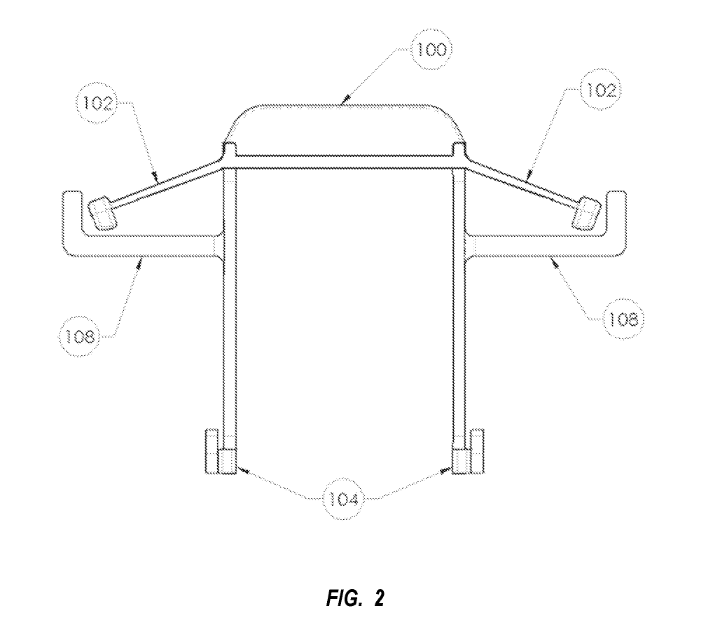

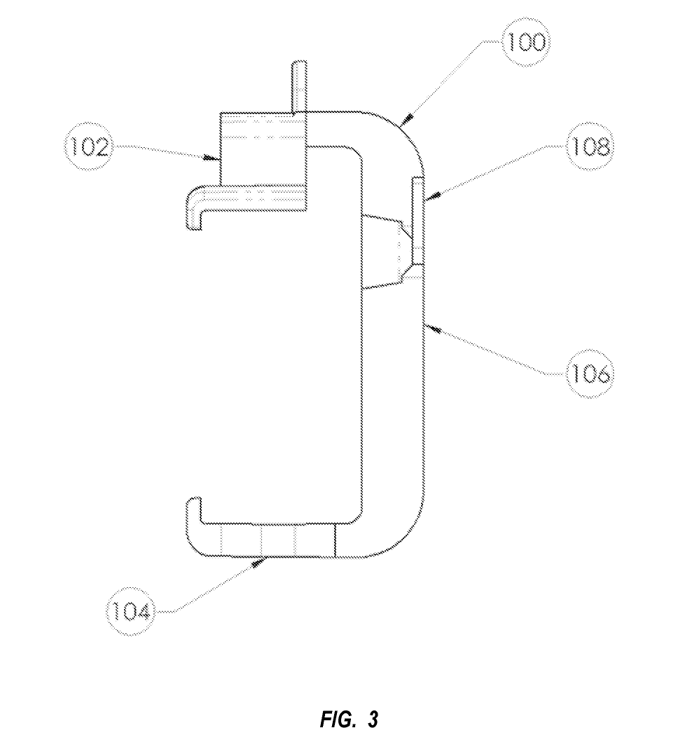

Attention is now directed to FIGS. 2 and 3, which illustrate the exemplary embodiment of the rearview mirror hanger 100 of FIG. 1 from front and side perspectives respectively. As seen in FIG. 2, the offset arrangement of the flex 102 and rigid opposing 104 members is easily noted from the front perspective, with flex members 102 set wide on the top and the rigid opposing members 104 located on the bottom and more central or medial to the flex members 102. While symmetrically spaced in this particular illustrated embodiment, it is to be understood that in an alternative embodiment, the arrangement of flex and rigid opposing members can vary with flex members being located centrally and rigid opposing members set wide in a lateral position relative to the flex members. Additionally, although the flex 102 and rigid opposing 104 members are illustrated as being laterally off-set from one another, in some embodiments the flex 102 and rigid opposing 104 members are laterally aligned with one another such that the flex members 102 are positioned vertically above the rigid opposing members 104.

Further still, in an alternative embodiment, the arrangement of flex and rigid opposing members can vary with alternate placement of members such that flex members alternate in placement with rigid opposing members. For example, a flex member may be located on the top, outside position as illustrated in FIG. 2 followed by a rigid opposing member on the bottom, also as illustrated in FIG. 2. In the alternative embodiment the first rigid opposing member could then be followed by a second flex member located on the top side, followed by a second rigid opposing member located on the bottom side. Such alternating of flex and rigid opposing members may be desirous for aesthetic detail and/or as well as functional design in order to assist attachment or fit of the rearview mirror hanger to a rearview mirror.

Hooks 108 in the exemplary embodiment are located nearer the tops of connecting members 106 so as to place them near the top edge of a mirror when the rearview mirror hanger 100 is attached to a rearview mirror. When the hooks 108 are located in this position, items hung from them will be hidden from driver or passenger view with the greatest possible potential, thereby minimizing interference or obstruction of the driver or passenger's view.

While located nearer the tops of the connecting members 106 in this particular illustrated embodiment, it is to be understood that in an alternative embodiment, the location of hooks 108 can vary in position along connecting members 106, even being located centrally or nearer the bottom of connecting members 106. Further still, in an alternative embodiment, the location of hooks 108 may differ in position along connecting members such that the hook 108 on the driver side is located nearer the top of connecting member 106, while the hook 108 on the passenger side is located nearer the center or bottom of connecting member 106. In still further alternative embodiments, the location of hook 108 on the passenger side may be nearer the top of connecting member 106 while the hook 108 on the driver side is located nearer the center or bottom of connecting member 106. In still further embodiments, there may be multiple hooks 108 located along the length of connecting member 106 such that there is a hook 108 nearer the top of connecting member 106 as well as a hook 108 located near the center of connecting member 106 as well as a hook 108 located nearer the bottom of connecting member 106. In addition, multiple hooks 108 may occur on the drivers side only, the passenger side only, or both driver and passenger sides. Further still, hooks 108 may be permanently attached as shown in the present embodiment, or they may be adjustably mounted for placement in the location desired by the user.

In still further embodiments there may be a hook 108 located nearer the top of connecting member 106 as well as a hook 108 located nearer the bottom of connecting member 106, or a hook 108 located nearer the top of connecting member 106 and a hook 108 located near the center of connecting member 106, or a hook 108 located near the center of connecting member 106 and a hook 108 located nearer the bottom of connecting member 106. In all of these various embodiments, hooks 108 may be configured in any desired combination when comparing the driver and passenger sides of rearview mirror hanger 100.

In addition, all possible configurations mentioned may have additional hooks 108 located singly or in multiple combinations extending from connecting members 106 at any angle from 0 to 180 degrees around connecting members 106 in relation to the position of hooks 108 as illustrated in FIG. 3.

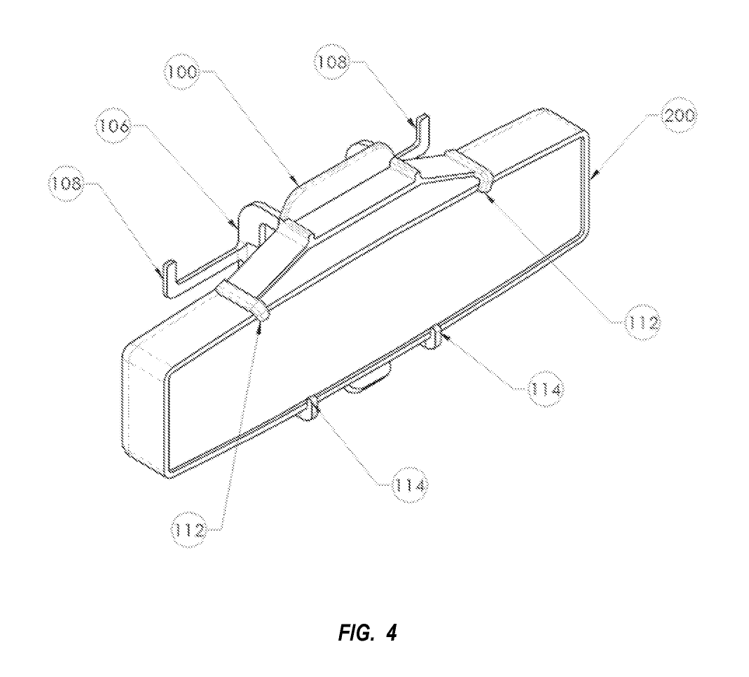

FIG. 4 illustrates attachment of the rearview mirror hanger 100 to a rearview mirror 200 with hooks 108 located behind the mirror and nearer the top of the connecting members 106 to maximize the hiding potential of the mirror and minimize obstruction of the driver's view when sunglasses, eyeglasses, or other items are hung from hooks 108.

Hooked tips 112 and 114 are purposely kept small to facilitate placement and stability of the rearview mirror hanger 100, while minimizing interference or obstruction of the reflection seen by the driver or passenger in the rearview mirror.

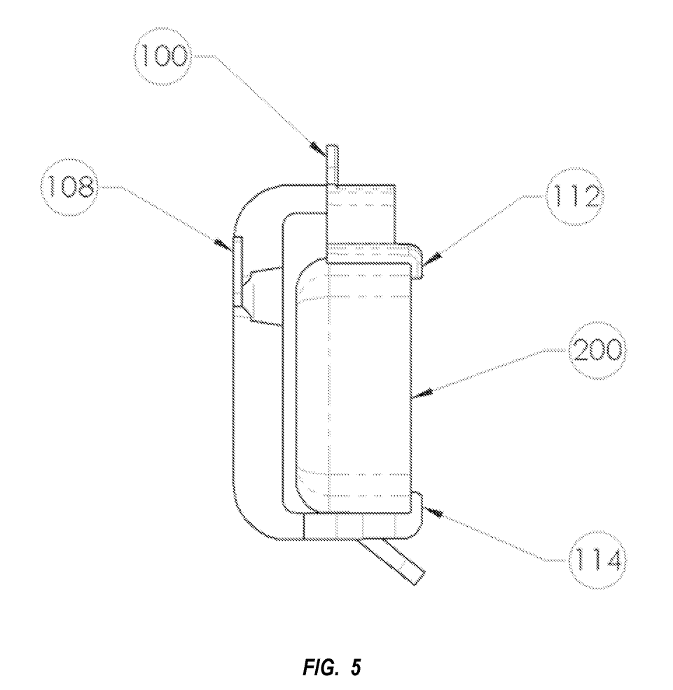

FIG. 5 illustrates the exemplary hanger 100 from a side perspective, attached to the rearview mirror 200. This perspective illustrates the clamping mechanism of the offset clamp design and placement of the hooks 108 behind the mirror 200 as well as minimal obstruction of the mirror surface by hooked tips 112 and 114.

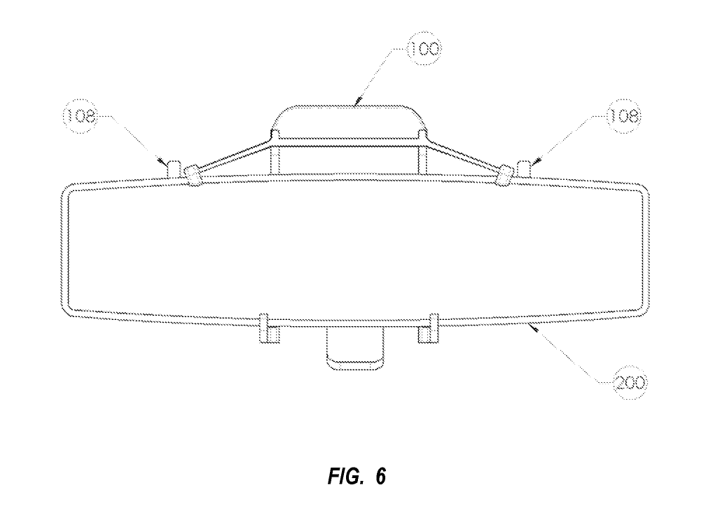

FIG. 6 provides a front view of hanger 100 attached to rearview mirror 200. This front view illustrates the hiding potential of hooks 108 when placed nearer the tops of connecting members 106 as any item, such as eyeglasses, hung from hooks 108 would be hidden from view by maximum placement behind mirror 200, thus providing minimal interference or obstruction of the driver or passenger view through the windshield.

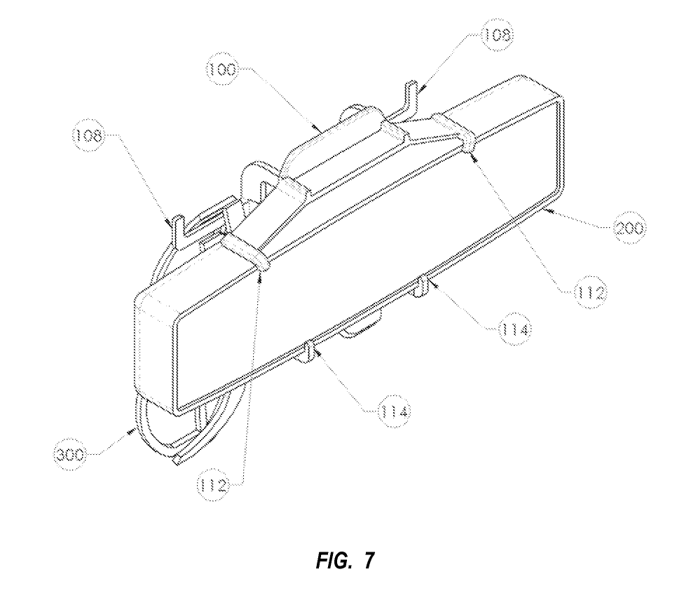

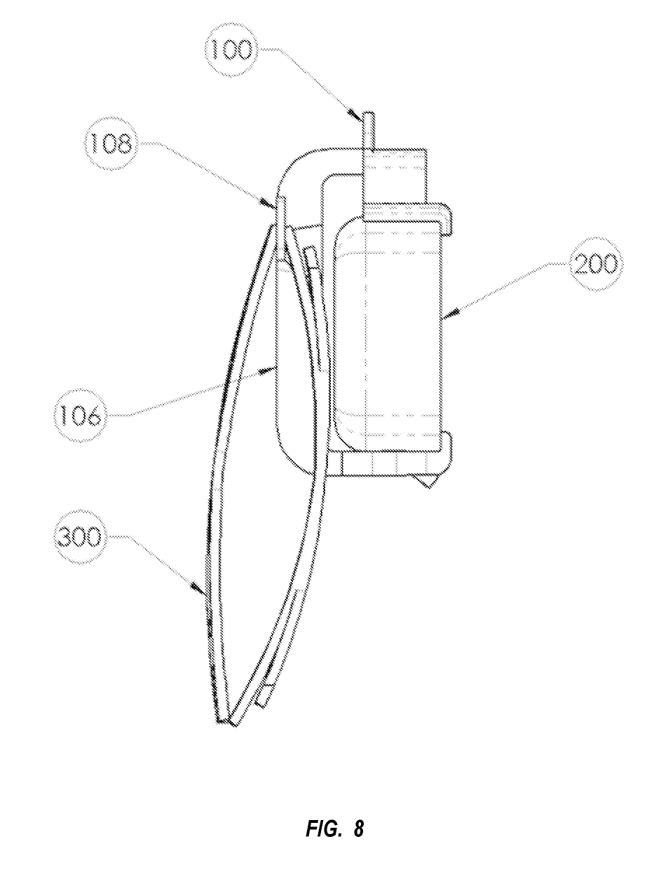

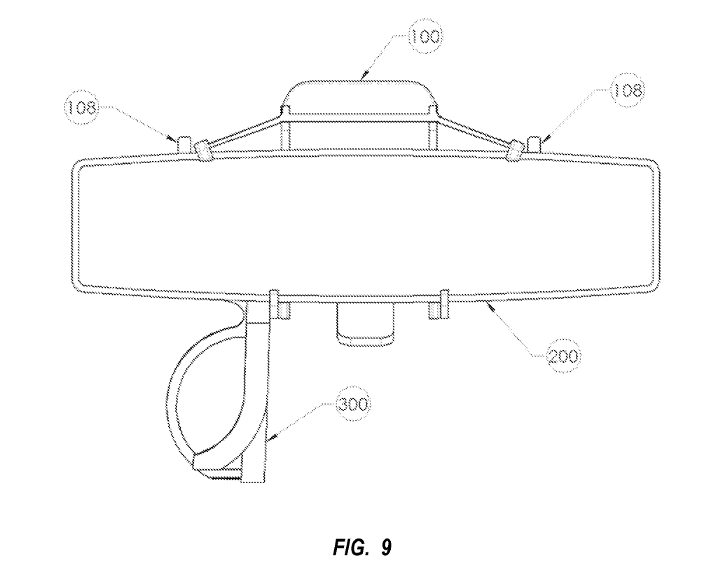

FIG. 7, FIG. 8 and FIG. 9 provide perspective, side and front views respectively of rearview mirror hanger 100 attached to rearview mirror 200 with eyeglasses 300 hanging from hook 108. The location of hook 108 nearer the top of connecting member 106 allows locating eyeglasses 300 behind rearview mirror 200 in such a way that a maximum of the eyeglasses 300 is hidden from view by mirror 200, which minimizes interference or obstruction of the driver or passenger view through the windshield.

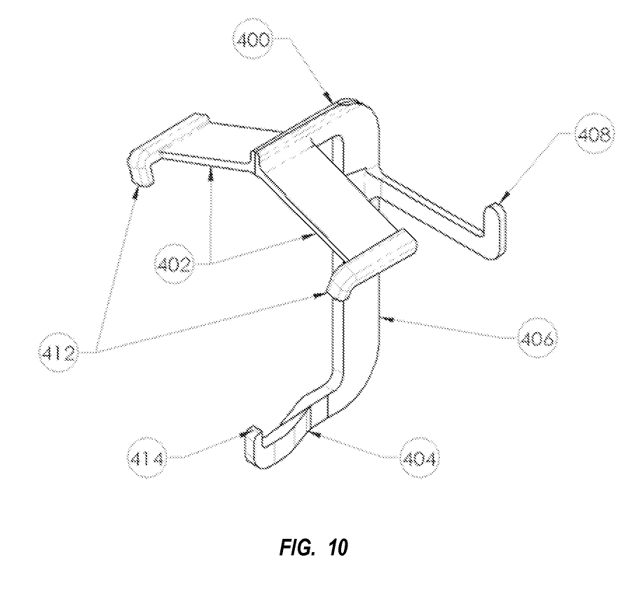

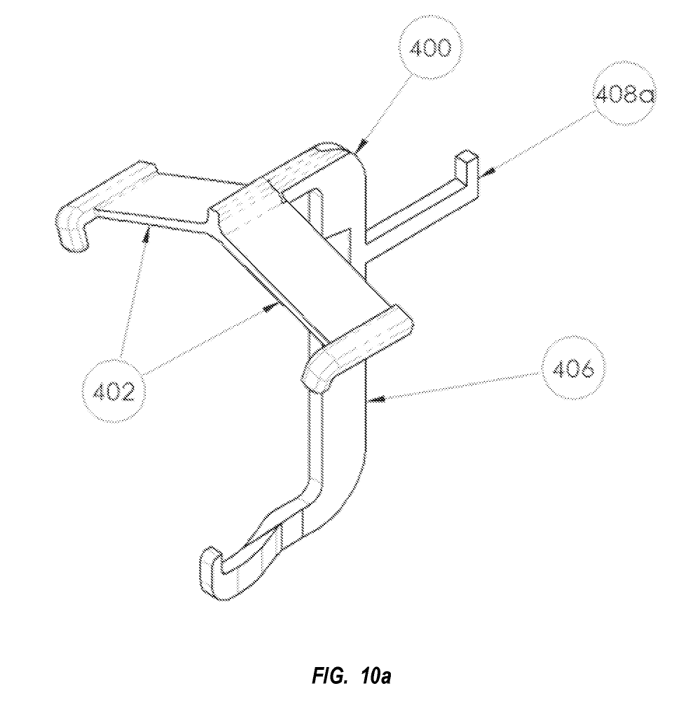

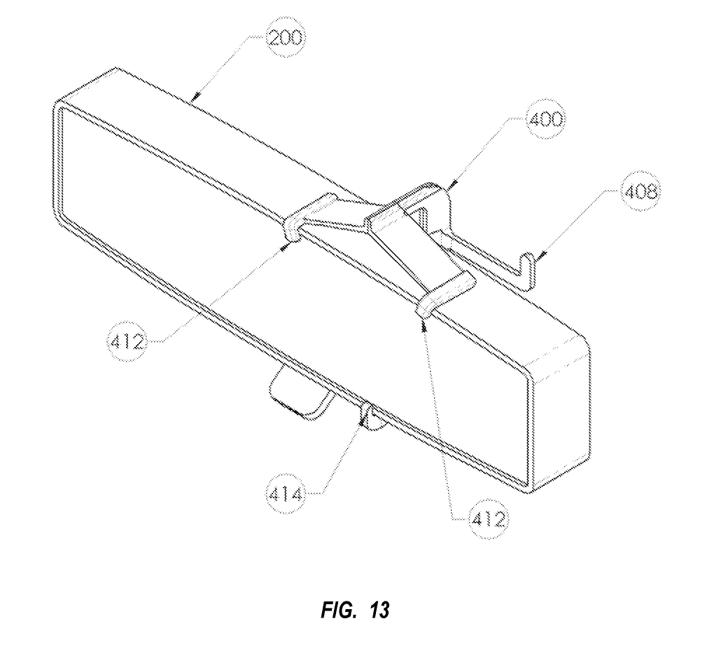

FIG. 10 illustrates an alternative embodiment that can include some or all of the features of the present disclosure. In FIG. 10, a rearview mirror hanger 400 is illustrated, which includes two flex members 402, one rigid opposing member 404, one connecting member 406, and one hook 408. This alternative embodiment is designed for attachment to one side of rearview mirror 200 as illustrated in FIG. 13, specifically the passenger side of a left side driver positioned vehicle of rearview mirror 200. An additional alternative embodiment for specific attachment to the driver side of rearview mirror 200 would be a mirror, left to right, image of the alternative embodiment 400, so that hook 408 was located on the opposite side of connecting member 406, which would provide for easy access to the driver of a left side driver positioned vehicle.

Flex members 402 of rearview mirror hanger 400 are directly attached to connecting member 406.

Connecting member 406 is continuously attached to rigid opposing member 404 to complete the clamping mechanism of the rearview mirror hanger 400. In addition, in this alternative system, hook member 408 is continuously attached to, and extends from connecting member 406, from which eyewear or other items may be hung or supported. In other embodiments, hook member 408a is attached to, and extends from rigid member 406 as illustrated in FIG. 10a. Additionally, hook members could extend from flex members 402 and/or rigid opposing member 404. Further still, hooks 408a may be permanently attached as shown in the present embodiment, or they may be adjustably mounted for placement in the location desired by the user.

In order to maintain position on a rearview mirror, hooked tips 412 on the flex members, and hooked tip 414 on the rigid opposing member 404 are included. Hooked tips 412 and 414 are purposely kept small to minimize any obstruction of the mirror surface so that the driver's view of reflected images from the mirror is unimpeded.

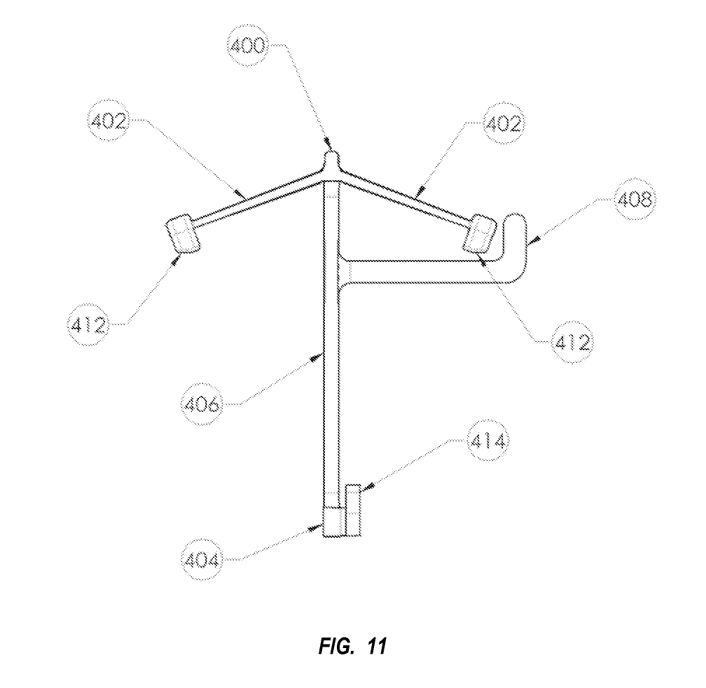

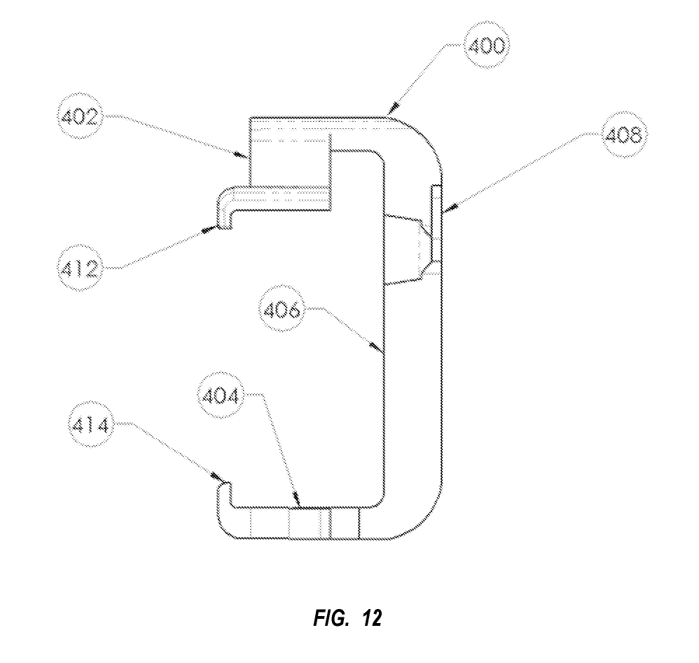

Attention is now directed to FIGS. 11 and 12, which illustrate the alternative embodiment of the rearview mirror hanger 400 of FIG. 10 from front and side perspectives respectively. As seen in FIG. 11, the offset arrangement of the flex 402 and rigid opposing 404 members is easily noted from the front perspective, with flex members 402 set wide on the top and the rigid opposing member 404 located on the bottom and more central or medial to the flex members. While symmetrically spaced in this particular illustrated embodiment it is to be understood that in an alternative embodiment, the arrangement of flex and rigid opposing members can vary with flex members being located centrally and rigid opposing members set wide in a lateral position relative to the flex members. Further still, in an alternative embodiment, the arrangement of flex and rigid opposing members can vary with alternate placement of members such that flex members alternate in placement with rigid opposing members.

Hook 408 in this alternative embodiment is located nearer the top of connecting member 406 so as to place it near the top edge of a mirror when the rearview mirror hanger 400 is attached to a rearview mirror. When the hook 408 is located in this position, items hung from it will be hidden from driver or passenger view with the greatest possible potential, thereby minimizing interference or obstruction of the driver or passenger's view.

While located nearer the top of the connecting member 406 in this particular illustrated embodiment it is to be understood that in an alternative embodiment, the location of hook 408 can vary in position along connecting member 406, even being located centrally or nearer the bottom of connecting member 406. In still further embodiments, there may be multiple hooks 408 located along the length of connecting member 406 such that there is a hook 408 nearer the top of connecting member 406 as well as a hook 408 located near the center of connecting member 406 as well as a hook 408 located nearer the bottom of connecting member 406.

In still further embodiments there may be a hook 408 located nearer the top of connecting member 406 as well as a hook 408 located nearer the bottom of connecting member 406, or a hook 408 located nearer the top of connecting member 406 and a hook 408 located near the center of connecting member 406, or a hook 408 located near the center of connecting member 406 and a hook 408 located nearer the bottom of connecting member 406. In all of these various embodiments, hooks 408 may be configured in any desired combination.

In addition, all possible configurations mentioned may have additional hooks 408 located singly or in multiple combinations extending from connecting member 406 at any angle from 0 to 180 degrees around connecting member 406 in relation to the position of hook 408 as illustrated in FIG. 12. Further still, hooks 408 may be permanently attached as shown in the present embodiment, or they may be adjustably mounted for placement in the location desired by the user.

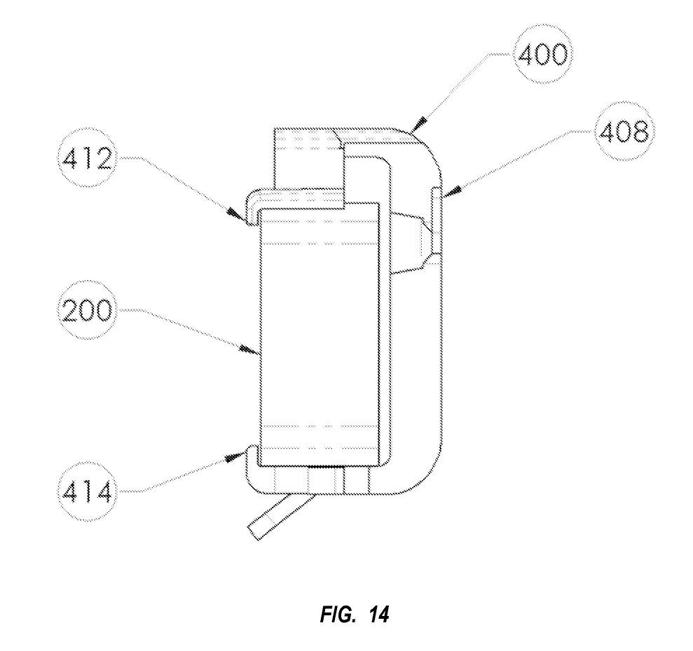

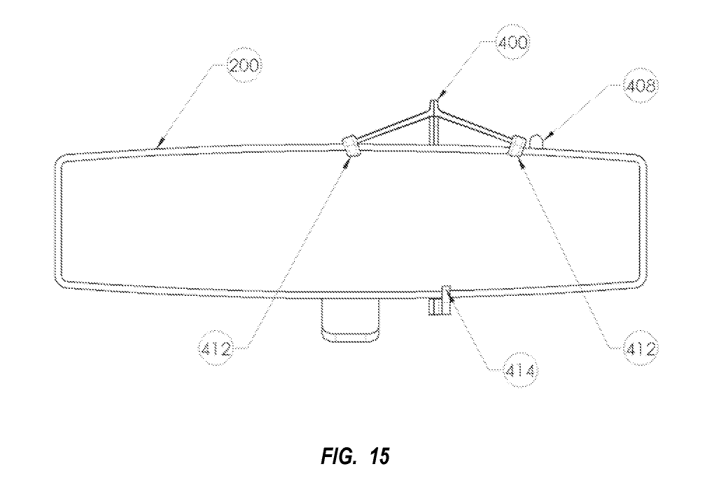

FIG. 13, FIG. 14, and FIG. 15 provide perspective, side and front views respectively of the alternative embodiment of rearview mirror hanger 400 attached to rearview mirror 200. As in the exemplary embodiment of rearview mirror hanger 100, the location of hook 408 is nearer the top of connecting member 406 which would allow locating eyeglasses or other items behind rearview mirror 200 with a maximum of the item being hidden from view behind mirror 200 which minimizes interference or obstruction of the driver or passenger view through the windshield.

In addition, FIG. 13, FIG. 14, and FIG. 15 illustrate this alternative embodiment 400 attached to a rearview mirror 200. These perspectives illustrate the clamping mechanism of the offset clamp design and minimal obstruction of the mirror surface by hooked tips 412 and 414.

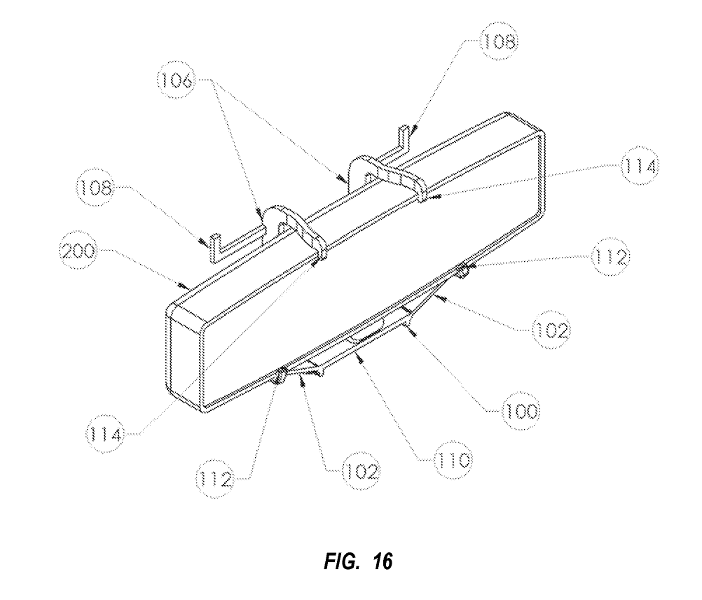

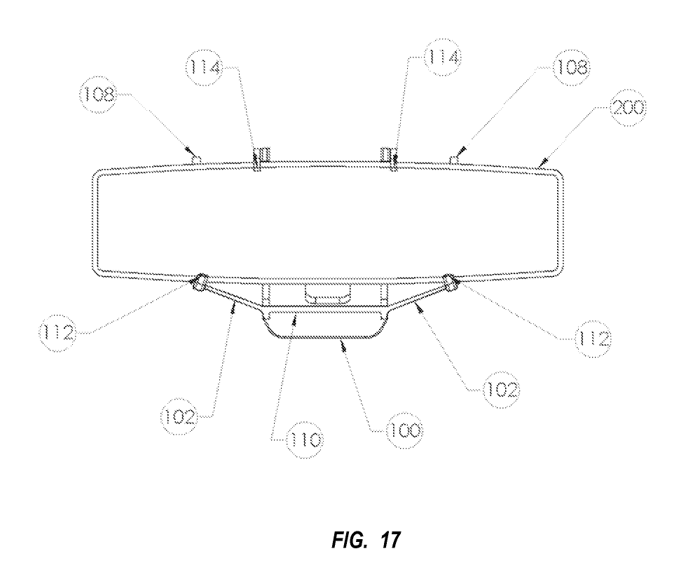

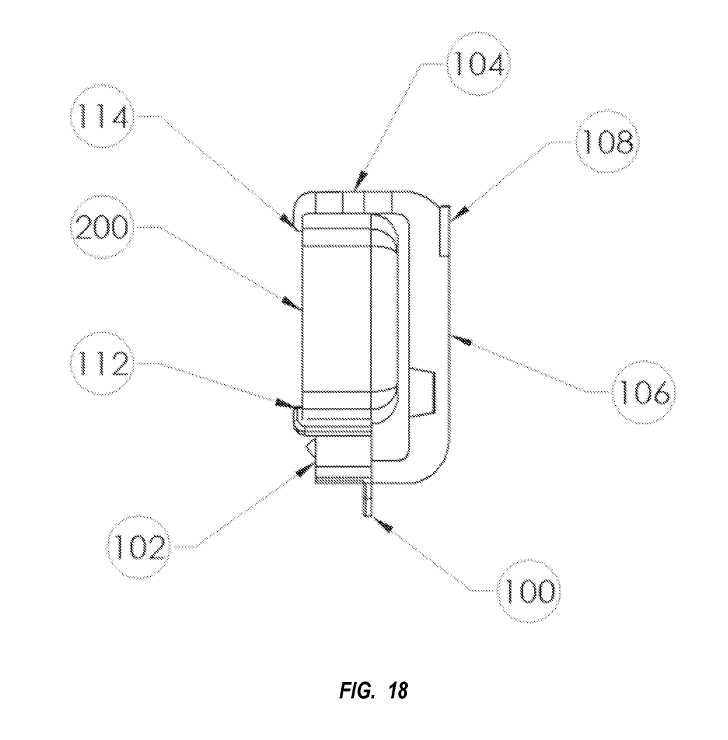

Alternatively, FIG. 16, FIG. 17, and FIG. 18 illustrate that rearview mirror hanger 100 of FIG. 1 can be configured with the rigid cross-member 110 and flex members 102 across the bottom edge of the rearview mirror, and rigid opposing members 104 located on the top edge of the rearview mirror.

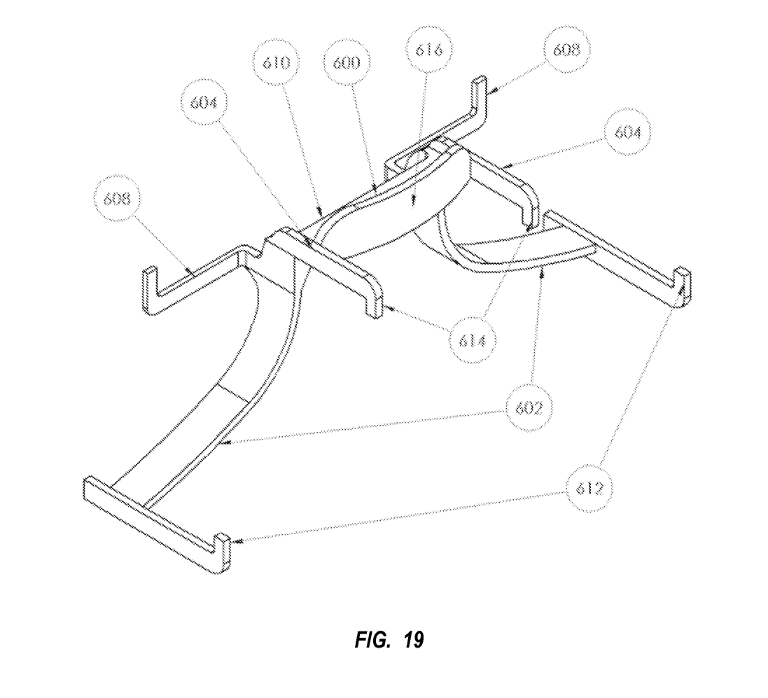

FIG. 19 illustrates an exemplary alternative embodiment of the rearview mirror hanger 600 with two flexing members 602 and two rigid opposing members 604 and hooks 608. While not a requirement, the connecting members 106 of FIG. 1 have been incorporated into the flexing members 602 of the design illustrated in FIG. 19. Flexing members 602 assist in installation of the rearview mirror hanger 600 to rearview mirrors of varying heights, while still providing adequate clamping force to retain the rearview mirror hanger on a variety of mirrors.

The flexing members 602 and all other parts of the rearview mirror hanger may be composed of a plastic such as ABS, Polycarbonate, Nylon, Polypropylene, Polyurethane, Silicone or other flexible polymers or mixtures of polymers and fillers such as glass or carbon fiber. Flexing members 602 and all other parts of the rearview mirror hanger may alternatively be composed of stamped and formed, machined, or otherwise shaped metal or metal wires, either bare or coated with a flexible coating or polymer. Flexing members 602 and all other parts of the rearview mirror hanger may also be made from naturally flexing materials such as wood, bamboo or other suitable plant or animal based materials or composites.

Materials used to create flexing members 602 should be elastic or have elastic segments, which allow the flexing members 602 to be flexed downward and toward each other for installation to, or removal from a rearview mirror. During installation to a rearview mirror, force is applied to the flexing members 602 to move them downwardly and toward one another other while the rearview mirror hanger 600 is positioned on the rearview mirror. Once the rigid opposing members 604 are in position along the top edge of the rearview mirror, and the hooked tips 612 on the flexing members are positioned along the bottom edge of the rearview mirror, the force applied to flexing members 602 is released allowing them to elastically move upward and away from each other. This elastic potential which attempts to return flexing members 602 to their relaxed starting position provides a retention force as flexing members 602 are prevented from returning to their fully relaxed state when they come into contact with the rearview mirror edge, thus effectively clamping the rearview mirror hanger 600 to the rearview mirror,

Removal of the rearview mirror hanger 600 from a rearview mirror requires a procedure similar to that used for installation. Force is applied to the flexing members 602 to move them downwardly and toward each other, which eliminates the clamping force applied to the rearview mirror. Once this clamping force is removed, the rearview mirror hanger 600 is free to be moved away from and off the rearview mirror. Once removed, the force applied to the flexing members may be released, allowing flexing members 602 to return to their initial fully relaxed position.

Flexing members 602 of rearview mirror hanger 600 are continuously connected by a rigid cross-member 610, which is located across the top edge of a rearview mirror when the rearview mirror hanger 600 is attached to the rearview mirror. Rigid cross-member 610 also continuously connects rigid opposing members 604 to flexing members 602 of the rearview mirror hanger 600.

In this exemplary system, hook members 608 are continuously attached to, and extend from flexing members 602, from which eyewear or other items may be hung or supported. In other embodiments, hook members 608 may be attached to, and extend from other locations and directions on flexing members 602, rigid cross-member 610, and/or rigid opposing members 604 similar to those illustrated and described in FIG. 1a.

In order to maintain position on a rearview mirror, hooked tips 612 on the flexing members 602, and hooked tips 614 on the rigid opposing members 604 are included. Hooked tips 612 and 614 are purposely kept small to minimize any obstruction of the mirror surface so that the driver's view of reflected images from the mirror is unimpeded.

Vertical rigid member 616 is included and attached to rigid cross-member 610 and may serve the purpose of adding strength and stiffness to rigid cross-member 610, or may serve a decorative purpose only by displaying a logo or other pattern or design, or it may serve a dual purpose of adding strength and stiffness to rigid cross-member 610 as well as a decorative purpose by displaying a logo or other pattern or design.

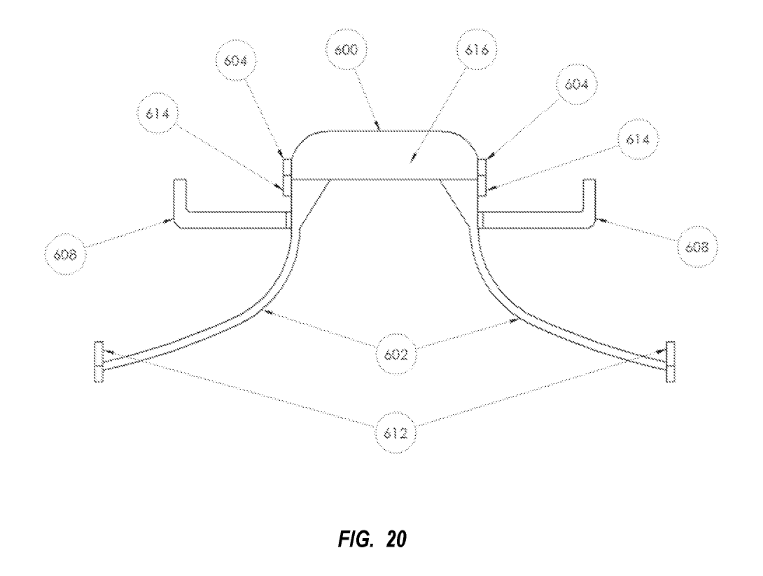

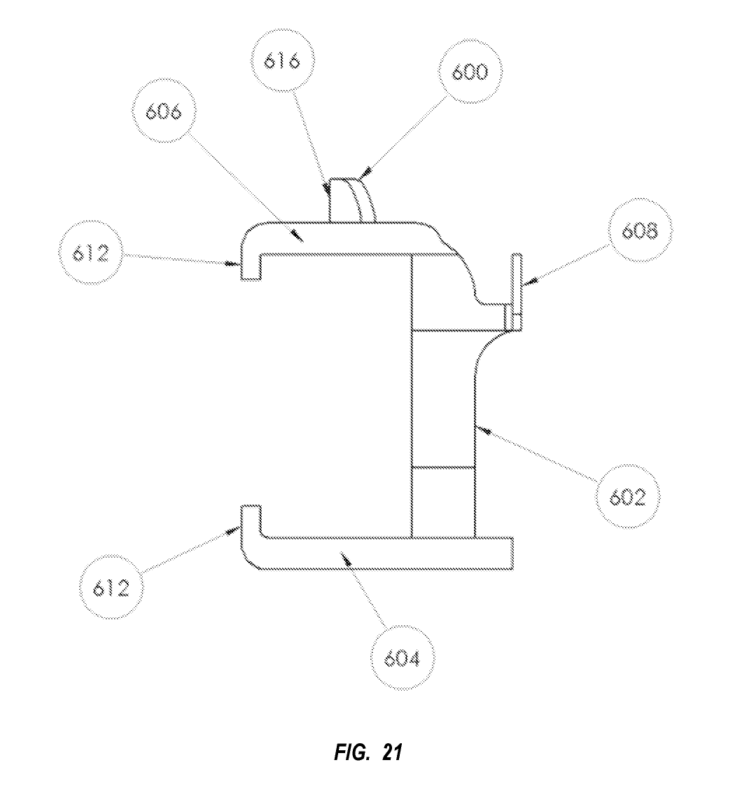

Attention is now directed to FIGS. 20 and 21, which illustrate the exemplary embodiment of the rearview mirror hanger 600 of FIG. 19 from front and side perspectives respectively. As seen in FIG. 20, the offset arrangement of the flexing members 602 and rigid opposing 604 members is easily noted from the front perspective, with flexing members 602 set wide on the bottom and the rigid opposing members 604 located on the top and more central or medial to the flexing members 602. While symmetrically spaced in this particular illustrated embodiment, it is to be understood that in an alternative embodiment, the arrangement of flexing and rigid opposing members can vary with flexing members being located centrally and rigid opposing members set wide in a lateral position relative to the flexing members. Additionally, although the flexing 602 and rigid opposing 604 members are illustrated as being laterally off-set from one another, in some embodiments the flexing 602 and rigid opposing 604 members are laterally aligned with one another such that the flexing members 602 are positioned vertically below the rigid opposing members 604.

Further still, in an alternative embodiment, the arrangement of flexing and rigid opposing members can vary with alternate placement of members such that flexing members alternate in placement with rigid opposing members. For example, a flexing member may be located on the bottom, outside position as illustrated in FIG. 20 followed by a rigid opposing member on the top, also as illustrated in FIG. 20. In the alternative embodiment the first rigid opposing member could then be followed by a second flexing member located on the bottom side, followed by a second rigid opposing member located on the top side. Such alternating of flexing and rigid opposing members may be desirous for aesthetic detail and/or as well as functional design in order to assist attachment or fit of the rearview mirror hanger to a rearview mirror.

Hooks 608 in the exemplary embodiment are located nearer the tops of flexing members 602 so as to place them near the top edge of a mirror when the rearview mirror hanger 600 is attached to a rearview mirror. When the hooks 608 are located in this position, items hung from them will be hidden from driver or passenger view with the greatest possible potential, thereby minimizing interference or obstruction of the driver or passenger's view.

While located nearer the tops of the flexing members 602 in this particular illustrated embodiment, it is to be understood that in an alternative embodiment, the location of hooks 608 can vary in position along flexing members 602, even being located centrally or nearer the bottom of flexing members 602. Further still, in an alternative embodiment, the location of hooks 608 may differ in position along flexing members such that the hook 608 on the driver side is located nearer the top of flexing member 602, while the hook 608 on the passenger side is located nearer the center or bottom of flexing member 602. In still further alternative embodiments, the location of hook 608 on the passenger side may be nearer the top of flexing member 602 while the hook 608 on the driver side is located nearer the center or bottom of flexing member 602. In still further embodiments, there may be multiple hooks 608 located along the length of flexing member 602 such that there is a hook 608 nearer the top of flexing member 602 as well as a hook 608 located near the center of flexing member 602 as well as a hook 608 located nearer the bottom of flexing member 602. In addition, multiple hooks 608 may occur on the drivers side only, the passenger side only, or both driver and passenger sides. Further still, hooks 608 may be permanently attached as shown in the present embodiment, or they may be adjustably mounted for placement in the location desired by the user.

In still further embodiments there may be a hook 608 located nearer the top of flexing member 602 as well as a hook 608 located nearer the bottom of flexing member 602, or a hook 608 located nearer the top of flexing member 602 and a hook 608 located near the center of flexing member 602, or a hook 608 located near the center of flexing member 602 and a hook 608 located nearer the bottom of flexing member 602. In all of these various embodiments, hooks 608 may be configured in any desired combination when comparing the driver and passenger sides of rearview mirror hanger 600.

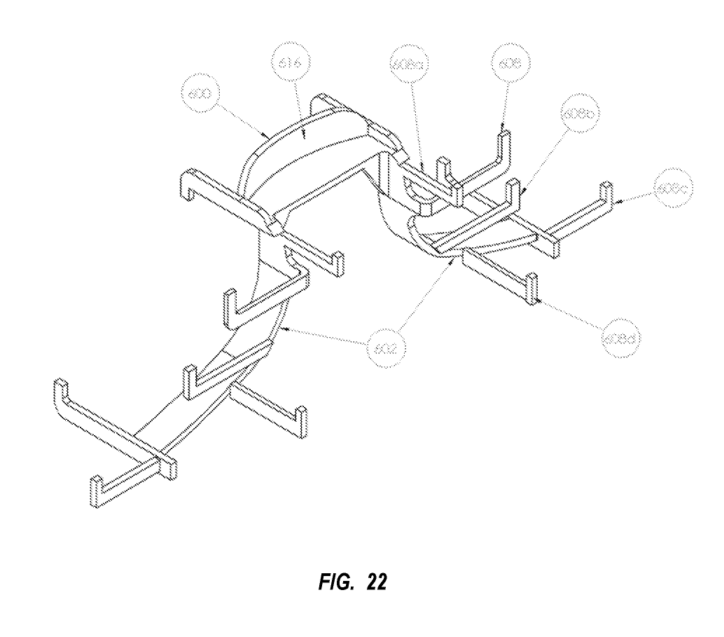

In addition, all possible configurations mentioned may have additional hooks 608 located singly or in multiple combinations extending from flexing members 602 and hooks 604 and 606, and at any angle from 0 to 180 degrees around flexing members 602 as illustrated by hooks 608, 608a, 608b, 608c, and 608d in FIG. 22.

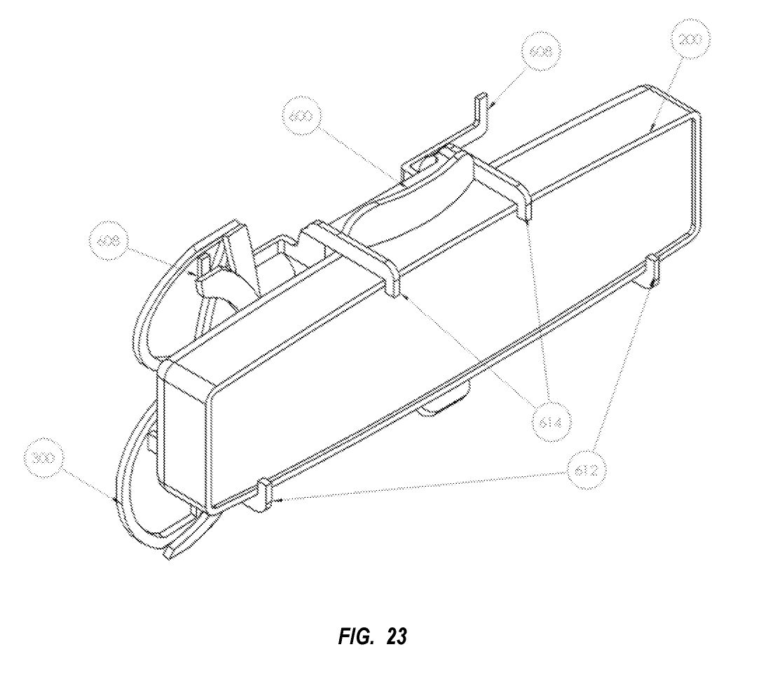

FIG. 23 illustrates attachment of the rearview mirror hanger 600 to a rearview mirror 200 with hooks 608 located behind the mirror and nearer the top of the flexing members 602 to maximize the hiding potential of the mirror and minimize obstruction of the driver's view when sunglasses, eyeglasses 300, or other items are hung from hooks 608.

Hooked tips 612 and 614 are purposely kept small to facilitate placement and stability of the rearview mirror hanger 600, while minimizing interference or obstruction of the reflection seen by the driver or passenger in the rearview mirror.

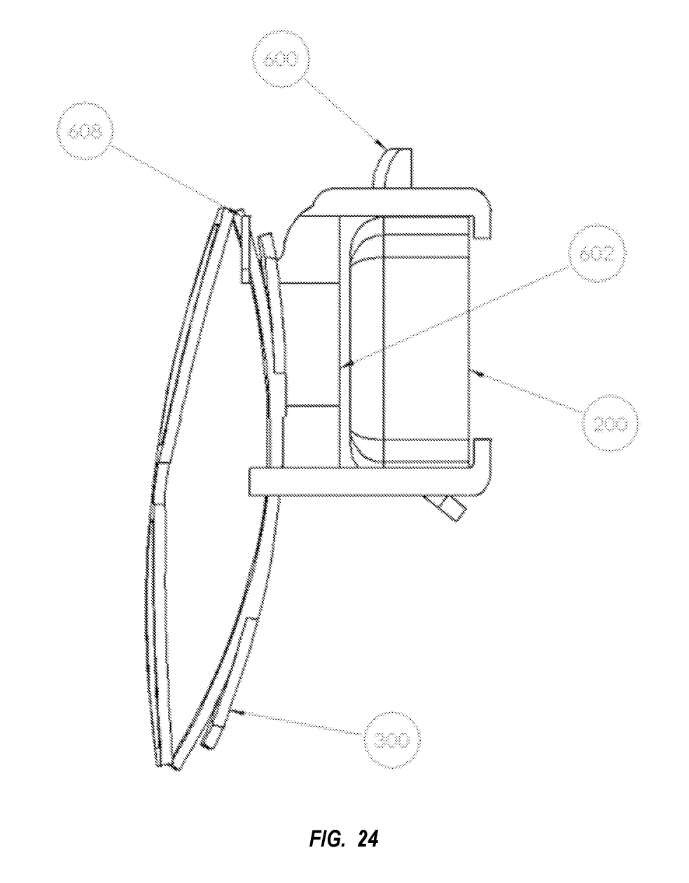

FIG. 24 illustrates the exemplary hanger 600 from a side perspective, attached to the rearview mirror 200. This perspective illustrates the clamping mechanism of the offset clamp design and placement of the hooks 608 behind the mirror 200 as well as minimal obstruction of the mirror surface by hooked tips 612 and 614. Eyeglasses 300 are hidden behind the mirror 200 with the least amount visible to obstruct the driver or passenger view through the windshield.

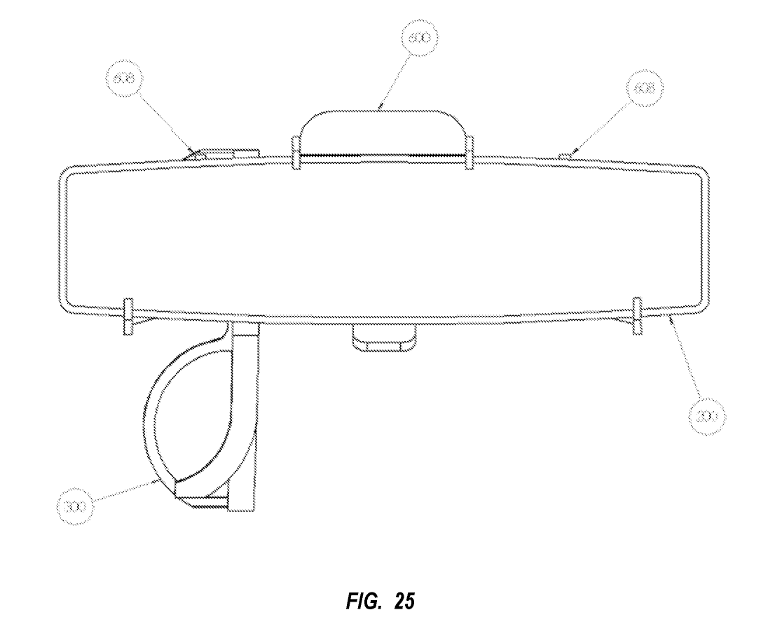

FIG. 25 provides a front view of hanger 600 attached to rearview mirror 200. This front view illustrates the hiding potential of hooks 608 when placed nearer the tops of flexing members 602 as any item, such as eyeglasses 300, hung from hooks 608 would be hidden from view by maximum placement behind mirror 200, thus providing minimal interference or obstruction of the driver or passenger view through the windshield.

What is claimed is:

1. A rearview mirror hanger that can be selectively attached to a rearview mirror and from which items can be hung, the rearview mirror hanger comprising:
a spring clamp comprising:
two flex members disposed on a first side of the spring clamp;
two rigid opposing members disposed on a second side of the spring clamp opposite the two flex members; and
one or more connecting members that connect the flex members and the rigid opposing members; and
one or more hooks attached to at least one of the one or more connecting members, the two flex members, or the two rigid opposing members, the one or more hooks being disposed vertically between the flex members and the rigid opposing members such that the one or more hooks are disposed substantially behind a rearview mirror when the rearview mirror hanger is attached to the rearview mirror.

2. The rearview mirror hanger of claim 1, the one or more connecting members include an area for decoration, logo, or other pattern or design.

3. The rearview mirror hanger of claim 1, wherein the one or more connecting members comprises a cross-member that connects the two flex members to one another.

4. The rearview mirror hanger of claim 1, wherein the one or more connecting members comprise a first connecting member that connects a first rigid opposing member of the two rigid opposing members to a first flex member of the two flex members.

5. The review mirror hanger of claim 4, wherein the one or more hooks include at least one hook connected to the first connecting member.

6. The rearview mirror hanger of claim 4, wherein the one or more connecting members comprise a second connecting member that connects a second rigid opposing member of the two rigid opposing members to a second flex member of the two flex members.

7. The review mirror hanger of claim 6, wherein the one or more hooks include at least one hook connected to the second connecting member.

8. The rearview mirror hanger of claim 1, wherein each of the two flex members and the two rigid opposing members includes a flex tip to facilitate attachment of the rearview mirror hanger to a rearview mirror.

9. The rearview mirror hanger of claim 1, wherein the two flex members are laterally off-set from the two rigid opposing members.

10. The rearview mirror hanger of claim 1, wherein the two flex members are laterally aligned with the two rigid opposing members.

11. A rearview mirror hanger that can be selectively attached to a rearview mirror and from which items can be hung, the rearview mirror hanger comprising:
a spring clamp comprising:
two flex members disposed on a first side of the spring clamp;
a rigid opposing member disposed on a second side of the spring clamp opposite the two flex members; and
one or more connecting members that connect the flex members and the rigid opposing member; and
one or more hooks attached to at least one of the one or more connecting members, the two flex members, or the rigid opposing member, the one or more hooks being disposed vertically between the flex members and the rigid opposing member such that the one or more hooks are disposed substantially behind a rearview mirror when the rearview mirror hanger is attached to the rearview mirror.

12. The rearview mirror hanger of claim 11, wherein the rigid opposing member is horizontally disposed centrally between the two flex members.

13. The rearview mirror hanger of claim 11, wherein the rigid opposing member is horizontally disposed closer to one of the two flex members than another of the two flex members.

14. A rearview mirror hanger that can be selectively attached to a rearview mirror and from which items can be hung, the rearview mirror hanger comprising:
a spring clamp comprising:
two flexing members disposed on a first side of the spring clamp;
two rigid opposing members disposed on a second side of the spring clamp opposite the two flexing members; and
one or more connecting members that connect the flexing members and the rigid opposing members; and
one or more hooks attached to at least one of the one or more connecting members, the two flexing members, or the two rigid opposing members, the one or more hooks being disposed vertically between the flexing members and the rigid opposing members such that the one or more hooks are disposed substantially behind a rearview mirror when the rearview mirror hanger is attached to the rearview mirror.

15. The rearview mirror hanger of claim 14, the one or more connecting members include an area for decoration, logo, or other pattern or design.

16. The rearview mirror hanger of claim 14, wherein the one or more connecting members comprises a cross-member that connects the two flexing members to one another.

17. The rearview mirror hanger of claim 14, wherein the one or more connecting members comprise a first connecting member that connects a first rigid opposing member of the two rigid opposing members to a first flexing member of the two flexing members.

18. The review mirror hanger of claim 17, wherein the one or more hooks include at least one hook connected to the first connecting member.

19. The rearview mirror hanger of claim 17, wherein the one or more connecting members comprise a second connecting member that connects a second rigid opposing member of the two rigid opposing members to a second flexing member of the two flexing members.

20. The review mirror hanger of claim 19, wherein the one or more hooks include at least one hook connected to the second connecting member.

21. The rearview mirror hanger of claim 14, wherein each of the two flexing members and the two rigid opposing members includes a flexing tip to facilitate attachment of the rearview mirror hanger to a rearview mirror.

22. The rearview mirror hanger of claim 14, wherein the two flexing members are laterally off-set from the two rigid opposing members.

23. The rearview mirror hanger of claim 14, wherein the two flexing members are laterally aligned with the two rigid opposing members.
